(19) United States
(12) Patent Application Publication
(10) Pub. No.: US 2011/0020609 A1
(43) Pub. Date: Jan. 27, 2011

(54) PANEL AND METHOD OF MAKING THE SAME

(76) Inventors: Steven Lynch, St. Charles, IL (US); Geoffrey Hardwick, St. Charles, IL (US); Timothy Gouge, Elgin, IL (US); Robert Allen, Elburn, IL (US); Bei-Hong Liang, Naperville, IL (US); Michael Macdonald, Batavia, IL (US); Peter Moran, Sligo (IE); Michael Halton, Longford (IE); Jonathan Pugsley, Roscommon (IE); Michael Conlon, Sligo (IE)

Correspondence Address: BERENATO & WHITE, LLC, 6550 ROCK SPRING DRIVE, SUITE 240, BETHESDA, MD, 20817, US

(21) Appl. No.: 12/840,596

(22) Filed: Jul. 21, 2010

Related U.S. Application Data
(60) Provisional application No. 61/227,142, filed on Jul. 21, 2009.

(51) Int. Cl. B32B 3/30; B27N 3/08; B28B 11/08; B32B 9/06; B32B 7/02

(52) U.S. Cl. 428/172; 264/239; 264/293; 428/218

(57) ABSTRACT

A panel and method of making a panel is disclosed. One described panel comprises a core comprising a flat region and a contoured region, wherein the contoured region comprises a convex feature, a first adjacent base and a second adjacent base, the apex of the convex feature has a first caliper, the first adjacent base has a second caliper smaller than the first caliper, and the second adjacent base has a third caliper smaller than the first caliper.

### CROSS-REFERENCE TO RELATED APPLICATIONS AND CLAIM TO PRIORITY

This patent application claims the benefit of U.S. Provisional Application No. 61/227,142, entitled “Panel and Method of Making the Same,” and filed Jul. 21, 2009, the entirety of which is incorporated herein and to which priority is claimed.

### FIELD OF THE INVENTION

The present disclosure relates generally to molded panels, articles using the molded panels and methods for manufacturing the same. In particular, the invention relates to the manufacture of molded wood composite door facings.

### BACKGROUND OF THE INVENTION

Molded panels are well known in the art and may be used in a variety of applications including, but not limited to, interior wall paneling, exterior siding, interior and exterior door facings or skins, cabinet doors or moldings. When a wooden appearance is desired, wood fiber composite materials such as fiberboard, paperboard, particleboard, oriented strand board, or oriented strand board composites with fiberboard or particle board may be used.

In certain applications, it may be desirable to provide the panel with design features such as moldings, depressions, contours, and decorative edges. These design features give a wood composite panel a more natural appearance. For example, a manufacturer may wish to give a door facing molded from a wood fiber composite material the appearance of a solid wood door. To accomplish this natural appearance, the facing may be given a number of contoured sloping walls extending into panel portions. The contoured walls may be provided with a number of convex peaks or beads, as well as a number of adjacent concave portions or coves; i.e., a bead and cove contour. These elements may be arranged so that the design features in the molded door facing give the appearance of millwork formed as part of a solid wood door.

A mat or blank of wood fiber material may be molded to form design features into a panel, for example via compression molding. Depending on the material and the density used for the mat, a variety of different operating parameters such as press time, pressure, and temperature may be used. Molding in such a manner has been found to be the most cost effective way to provide uniform panels at a high rate. The manufacture and appearance of these panels, however, may have several limitations and disadvantages.

When forming a panel from a wood fiber mat, the thickness of the wood fiber mat is often reduced, which in turn increases variation in its density based on thickness differences within the profile zone. When design features are included in the panel, the thickness of the panel will vary at different points. This has lead to inconsistencies with the appearance of the panel. As the thickness varies, the density of the material and its coloration will also vary. Those skilled in the art understand that the density of the resulting panel is the inverse of its thickness, because the panel is typically formed from a wood fiber mat of uniform thickness. Additionally, the variations in density will lead to inconsistencies when the panel is painted. Density variations cause the panel to absorb paint at by different amounts, resulting in a non-uniform coat. This is especially true in contoured design features of a molded panel.

Prior attempts to correct the inconsistency of density variations have resulted in molding techniques which produce panels having a more uniform thickness. This technique, however, was ineffective in creating a constant density where required and led too other drawbacks and limitations. When maintaining a constant thickness (and thus thickness), limits are placed on the angles and radii of curvature which can be formed into the panel. Also, a thicker mat must be used to prevent fracturing during the molding process. The use of a thicker mat results in more material being used per panel and a heavier end product. Additionally, when trying to maintain a constant thickness during the molding process, fracture of the mat will often occur at the surface of bead portions, requiring the panel to be mended or scrapped, resulting in higher production costs and wasted time.

Thus there is a need for a panel and a method for making panels which reduces the amount of material used per panel while also reducing fracturing on the surface of the mat.

### BRIEF SUMMARY OF THE INVENTION

The present invention is directed to a panel and a method for making the same. In particular, the invention is directed to wood composite door facings and their manufacture. In accordance with one embodiment, a panel comprises a core comprising a flat region and a contoured region, wherein the contoured region comprises a convex feature, a first adjacent base and a second adjacent base, the apex of the convex feature has a first caliper, the first adjacent base has a second caliper smaller than the first caliper, and the second adjacent base has a third caliper smaller than the first caliper.

The present invention is also directed to a method for making a panel. The method comprises the steps of providing a mat of wood fiber material, forming a flat region in the mat of material, forming a contoured region in the mat of material, and forming a convex feature in the mat of material, the convex feature comprising an apex with a first caliper, a first adjacent base with a second caliper, and a second adjacent base with a third caliper in the contoured region, wherein the second caliper and the third caliper are formed smaller than the first caliper.

Other aspects of the invention, including apparatus, systems, methods, and the like which constitute part of the invention, will become more apparent upon reading the following detailed description of the exemplary embodiments and viewing the drawings.

### BRIEF DESCRIPTION OF THE DRAWINGS

The accompanying drawings are incorporated in and constitute part of the specification. The drawings, together with the general description given above and the detailed description of the exemplary embodiments and methods given below, serve to explain the principles of the invention. In such drawings:

FIG. 1 is a plan view of a wood fiber mat;

FIG. 2 is a fragmentary sectional view of a conventional panel;

FIG. 3 is a fragmentary sectional view of a panel according to one embodiment of the invention;

FIG. 4 is a fragmentary sectional view of a panel according to another embodiment of the invention;

FIG. 4A is a fragmentary cross-sectional view of a die set used to make the panel of FIG. 4;

FIG. 5 is a fragmentary sectional view of a panel according to another embodiment of the invention;

FIG. 5A is a fragmentary cross-sectional view of a die set used for manufacturing the door facing of FIG. 5; and,

FIG. 6 is a flow diagram of a method according to another embodiment of the invention.

### DETAILED DESCRIPTION OF THE PREFERRED EMBODIMENT(S)

Reference will now be made in detail to exemplary embodiments and methods of the invention as illustrated in the accompanying drawings, in which like reference characters designate like or corresponding parts throughout the drawings. It should be noted, however, that the invention in its broader aspects is not limited to the specific details, representative devices and methods, and illustrative examples shown and described in this section in connection with the exemplary embodiments and methods. The invention according to its various aspects is particularly pointed out and distinctly claimed in the attached claims read in view of this specification, and appropriate equivalents.

The elimination of the brown line appearance on molded high density fiberboard (“HDF”) components, seen as objectionable quality on prime coated skins at the peak point of small radius deflection elements visible on the show side within certain historically produced profile surfaces, is desirable. Brown line defects result from insufficient density at points on the surface of a molded HDF component, which inhibits proper and necessary fiber consolidation. The insufficient density is caused by inability of fibers to flow sufficiently into tight radius corners under the pressure applied to mold the mat during the manufacturing process. Articles and methods according to the present invention, however, eliminate objectionable brown line occurrence while lowering the overall density of the formed component. The disclosed invention incorporates a wide range in mat density without changing the brown line elimination capability. By eliminating brown line and lowering the overall density of the molded component, the material consumption and overall costs of production are reduced.

To accomplish the dual objectives of eliminating brown line while reducing the amount of wood fiber materials needed for a panel, panels and methods according to the present invention have to account for the required compaction needed where brown line defects normally occur, while still allowing for reduction of the overall basis weight. Panels and methods according to the invention integrate both of these divergent objectives by controlling the dynamics of material conversion within a set of manufacturing processing parameters. Brown line defects can be reduced or eliminated through a density gradient, or reduced density approach. In a density gradient approach, the density of a panel is controlled, or manipulated, such that a sufficient density is maintained at a first major surface of a panel, while the adjacent core and the opposite surface of the panel each have a lower density. The density of the panel is maintained, or kept substantially constant, at the first major surface, where the constant density is needed for toughness and integrity, while the density decreases through the core of the panel to the second major surface.

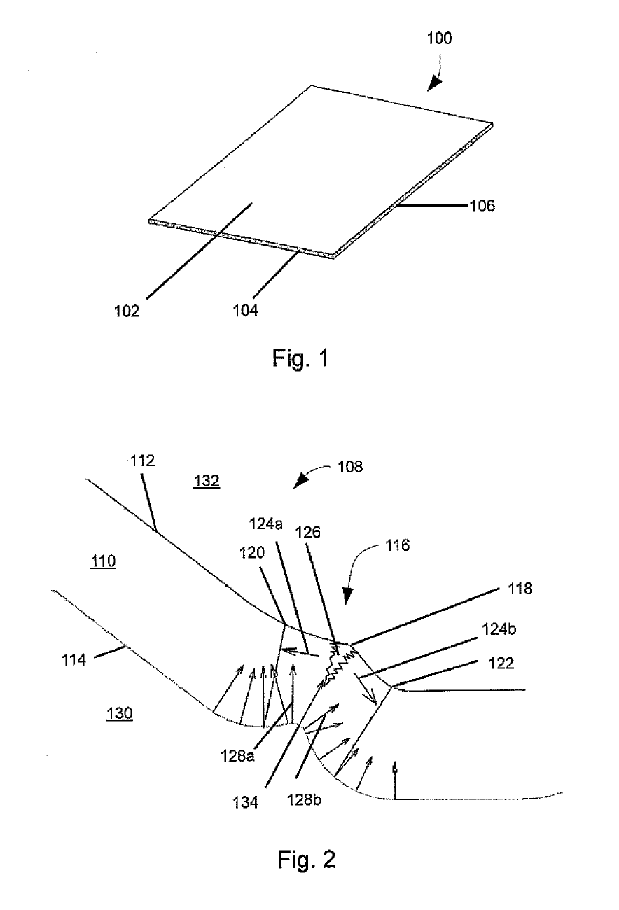

The exemplary embodiments shown in the figures and discussed herein will focus on a panel molded to be used as a door facing. The panel, however, is not meant to be so limited, and may be used in a variety of applications. As shown in FIG. 1, a wood fiber mat 100 is provided to be formed into a molded three dimensional panel useful as a door facing. The wood fiber mat 100 has a first surface 102 on the top of the mat 100, a second surface 106 on the bottom of the mat, oppositely disposed the first surface 102, and a core 104 disposed between the first surface 102 and the second surface 106. The mat 100 is a wood fiber composite material, although flakes, wafers, particles, strands, or mixtures thereof may be used. The mat 100 is preferably formed from wood fibers, and more preferably formed into a high density fiberboard. The material of the mat 100 may be sprayed with a resin binder material and formed to have a generally uniform basis weight. Methods of forming mats such as mat 100 are known in the art. An example of forming a wood fiber mat is further described in commonly owned U.S. Pat. No. 6,511,567, incorporated herein by reference.

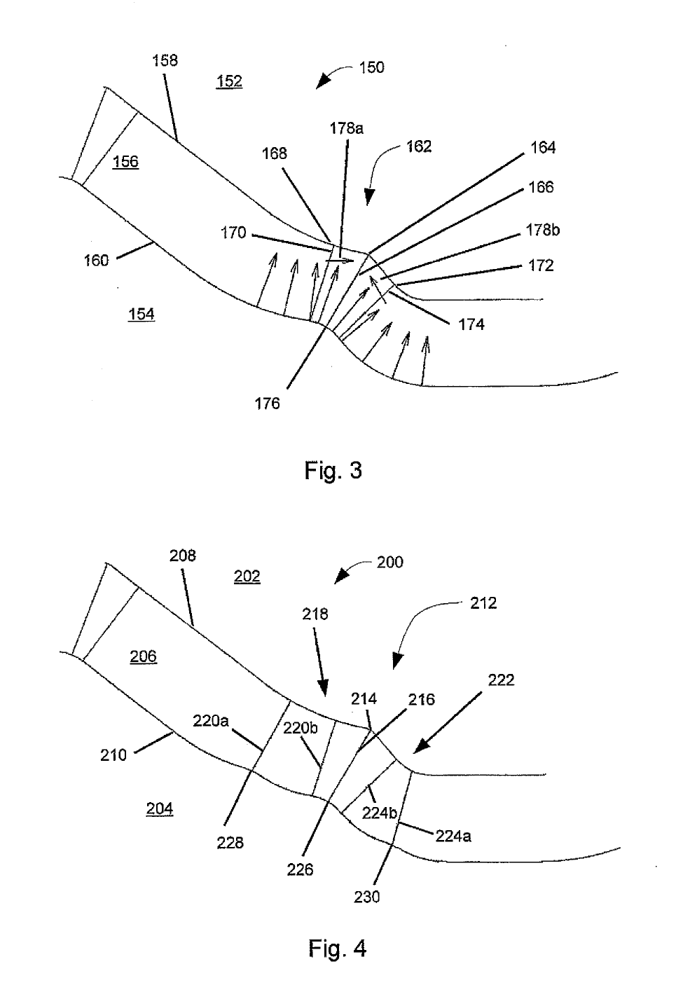

FIG. 2 illustrates a panel 108 manufactured according to a conventional method. The panel 108 comprises a core 110, a first surface 112 on the face side 132 of the panel 108, and a second surface 114 on the cavity side 130 of the panel 108. The panel 108 further comprises a convex design feature 116 comprising an apex 118, a first adjacent base 120, and a second adjacent base 122. The convex design feature 116 resembles or looks like a peak or a bead. In conventional panels, such as the one shown in FIG. 2, the caliper of the apex 118 of the convex feature 116 is less than the caliper of the first adjacent base 120 and the caliper of the second adjacent base 122. In other words, the thickness of the panel 108 at the apex 118 of the convex design feature 116 is thinner than the thickness of the panel 108 on either side of the convex design feature 116 adjacent to the apex 118.

Conventional HDF panels, such as illustrated in FIG. 2, require a consistent density to maintain satisfactory performance properties for satisfactory surface quality and strength. During panel formation, HDF mats do not act as a fluid material under heat and pressure. Thus, conventional techniques for molding HDF mats into contoured configurations conform the corresponding increases in length created by the extended non-flat profile segments by reducing the volume of the HDF by a corresponding amount. To compensate for changes in angular deflection, further compression has been required to attempt to push fiber into opposing corners to maintain consistent surface fidelity. If the deflection angle is greater than 38 degrees between adjacent planes and the radius on the convex side is equal to or less than 0.031 R it becomes very difficult to properly consolidate the opposing surface fiber (face side) on a molded nominal ⅛″ panel by using a point push from the cavity side of the profile design.

In such a geometric configuration, the dynamics of the material of the mat cause the mat to fracture during closure of the die press. Specifically, because the required density does not transfer all the way through from the cavity side 130 of the core 110 to the opposing surface 112 on the face side 132, the opposing surface 112 does not sufficiently reconsolidate where the mat initially separated to bring the necessary density in the small radius location on the opposing side. When the opposing surface 112 cannot reconsolidate, the opposing surface 112 fractures 126 at the apex 118 of the convex feature 116 on the side away from the contact point 134.

The fractures 126 are indicative of a variable density across the surface 112 of the panel 108, and are endemic to conventional panels with convex design features. The variable density of prior conventional panels is most evident in regions where a convex design feature 126 is formed. As best shown in FIG. 2, when creating such a design feature in a conventional panel 108, the cavity side surface 114 of the panel 108 is pushed into the core 110 and towards the opposite surface 112. The compression in this region results in a shifting of the fibers. This is due to internal forces acting normal to the radius of curvature as indicated by the arrows 124a, 124b. These internal forces push fiber away from the convex design feature 116, resulting in a decrease in density at the convex design feature and fracturing 126 at the apex 118.

The fracturing 126 of the panel 108 yields a localized low-density area 126. If the panel fractures on the display side (i.e. show side) of the panel, the localized low-density area produces an objectionable change in the surface quality, known as “brown line.” The brown line results from paint soaking into the surface at the localized low-density area rather than forming a film directly on a properly densified surface.

Unlike panels according to the prior art, methods according to the present invention permit wood fiber materials to be forced into tight small radius configurations with deflection angles of up to 45 degrees or more from the flat region of a panel. By utilizing methods according to the present invention, brown line defects in HDF panels can be reduced or eliminated. Furthermore, embodiments of the invention allow a broad range of acceptable fiber density to be pressed without experiencing defects resulting from conventional methods. The minimum basis weight is lowered from about 1.02 specific gravity down to about 0.85 specific gravity. At the lower end of the density range these design parameters allow satisfactory component quality to be pressed down to an overall average of 0.85 specific gravity in the flat zones and to still achieve necessary densities where needed in the profiled areas to eliminate brown line. Embodiments also allow for using mats with a wide range of densities, from lower densities to higher densities, with the same core cavity design.

Using principles according to embodiments of the present invention facilitates progressive movement of gasses from profile extremes (i.e. areas of the panel furthest from the flat zone, or at the highest angle of deflection from the flat zone) to the flat, base caliper zones. This progressive movement of gasses broadens the processing window and allows the formation of high density areas without fracturing and/or blistering, avoiding manufacturing yield losses due to production defects. Thus, embodiments of the present invention reduce resource materials and operating costs while maintaining visual and functional performance properties satisfying market expectations.

The present invention provides a panel and a method of making the same which overcomes disadvantages of the prior art. Through specific design features, panels according to methods and articles of the present invention have a substantially uniform density across the surface of the face side of the panel, with the density decreasing through the core of the panel to the surface of the cavity side of the panel. Due to the substantially uniform surface density, the panel will have a consistent appearance when given a uniform coat of paint. Additionally, the panel may be formed with a greater variety of design features and sharper features than prior panels. This enables a manufacturer to give a wood fiber composite material the appearance of a solid product with milled design features. Due to the density gradient through the depth of the panel, a mat having a reduced initial density may be used without risk of fracturing during molding, resulting in a lighter final product and requiring the use of less material.

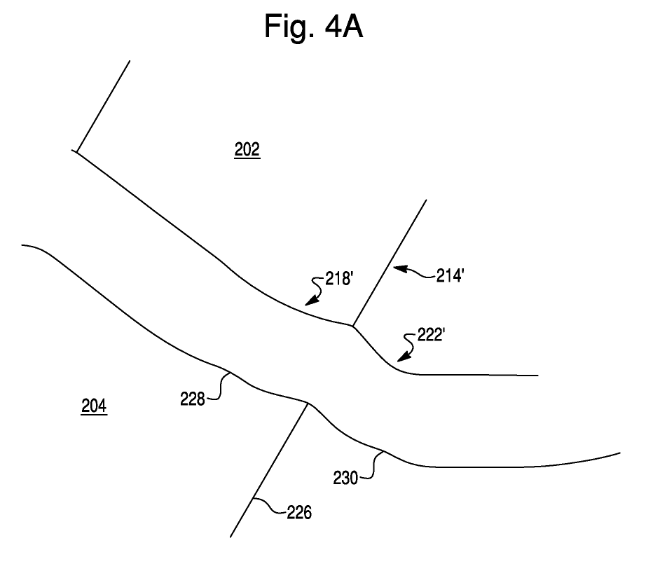

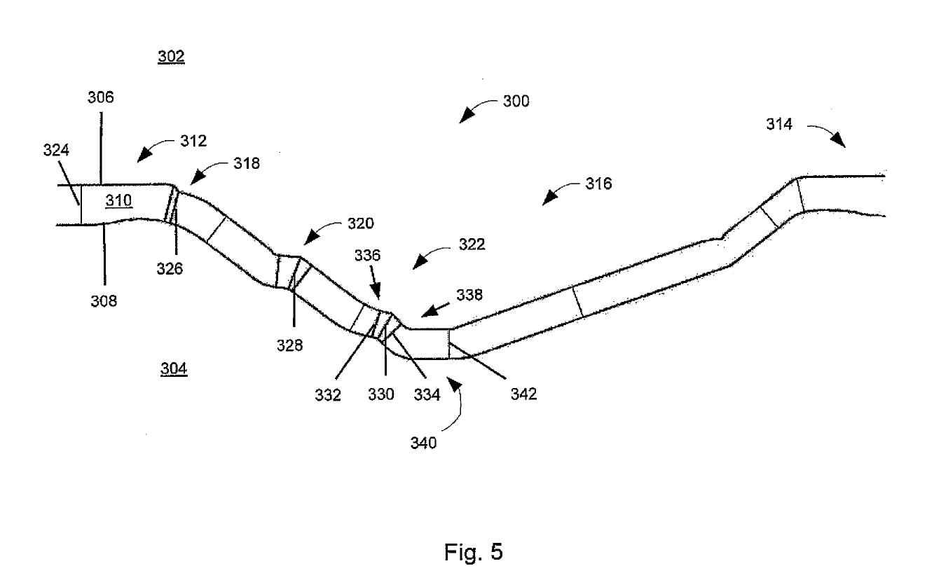

In two exemplary embodiments shown in FIGS. 3 and 4, the required density gradient is achieved by forming the panel so that the internal forces created during its formation push wood fiber material towards the face side surface and into the apex of convex design features, instead of away from them. One way of achieving this is by adjusting the thickness of the panel at specific locations. Preferably, the thickness, or caliper, of the adjacent base areas surrounding the apex of each convex design feature should be less than the thickness at apex of the convex design feature. The caliper of each adjacent base area may be 1%-8% less than the caliper of the apex. In one example, the thickness or caliper of each adjacent base is 0.005 inches to 0.008 inches less than the thickness of the apex. Additionally, the variable density may be further assisted by increasing the thickness of the panel progressively from the deepest point of the panel toward the flat regions of the panel. For example, the panel may be 0.076 inches thick at its lowest point and 0.117 inches thick at the flat regions. Progressively increasing the thickness of the panel from its lowest point to the flat regions allows venting of gases and moisture during the molding process.

Usually, a variation in the thickness at a first section with respect to a second section will result in a density variation between the two sections. However, when the caliper of the apex is more than the caliper of the adjacent bases, the internal forces during formation tend to push wood fiber material toward the top or apex of the convex design feature and the face side surface of the panel, resulting in a substantially constant surface density. Additionally, this creates a density gradient, or a decrease in density, through the core of the panel. During panel formation, fiber material is pushed into tight radius configurations and permits greater deflection angles to be utilized. The density gradient of the panel is related to the thickness of the panel at any given section. Therefore, at certain sections, specifically those that are the thinnest, the overall reduction in density from the cavity side surface to the face side surface of the panel will be relatively small. Because material is being moved from the cavity side surface of the panel toward the face side surface, fiber mats used to form the panel may start with a reduced density, while still having a sufficient surface density to create desired design features.

In some panels, the compression of a single section of a panel will not exceed the measured thickness of the flat regions by more than 35%. Volume reduction values within the panel at certain points may fall between 0-30% less than flat regions, and more commonly between 10-25%.

The amount of pressure applied to the mat of wood fiber material is a result of a pattern formed by the male and a female dies. The female die will have a pattern identical to the surface 26 of the finished panel. The male die will have a corresponding pattern which is identical to the surface 22 of the panel 20. When the male and female dies are moved towards each other, the respective patterns will form an open space with a thickness or gap corresponding to the thickness of the panel 20 at each individual point. This will allow the appropriate amounts of pressure to be applied to the mat during the molding operation. The dies may be brought together by an actuating cylinder such as a hydraulic or pneumatic cylinder, though any suitable means may be used to provide movement between the first die and the second die. The dies typically are heated to a temperature between approximately 275° F. and 500° F. Additionally, the pressure applied to the dies may be between approximately 0 to 4000 psi. The panel 20 may be formed with a single press of the dies or multiple stepped presses may be used. Further descriptions of the types of presses and methods used in making similar panels are described in commonly owned U.S. Pat. Nos. 6,743,318 and 7,426,806, incorporated herein by reference.

FIG. 3 is a fragmentary sectional view of a panel according to one embodiment of the invention. A panel 150 comprises a core 156, a first surface 158 on a face side 152 of the panel 150, and a second surface 160 on a cavity side 154 of the panel 150. The panel 150 further comprises a convex design feature 162 comprising an apex 164, a first adjacent base 168, and a second adjacent base 172. During formation of a fiber mat into the panel 150, the convex design feature 162 is formed as the fiber mat is pressed against a cavity die (not shown in FIG. 3) on the cavity side 154 of the panel 150. A contact point 176 between the panel 150 and the cavity die is shown on the cavity side 154 of the panel 150. The contact point 176 pushes a section of the panel 150 toward surface 158, thereby forming the convex design feature 162.

The top, or apex 164, of the convex design feature 162 has a first caliper 166, or thickness, as measured between the apex 164 of the convex design feature 162 and the contact point 176, i.e. the point opposite the apex 164 on the cavity side 154 of the panel 150. The first adjacent base 168 has a second caliper 170 less than the first caliper 166, and the second adjacent base 172 has a third caliper 174 less than the first caliper 166.

Because the caliper 170 of the first adjacent base 168 and the caliper 174 of the second adjacent base 172 are less than the caliper 166 of the apex 164, fiber material from the mat is forced towards the apex 164 as shown by arrows 178a, 178b. The flow of fiber towards the apex 164 ensures that the surface of the convex design feature 162, from the first adjacent base 168 across the apex 164 to the second adjacent base 172, is substantially uniform. The substantially uniform density of the surface of the convex design feature 162 prevents fracturing of the panel, thus eliminating brown line defects.

While the surface 158 across the convex design feature 162 comprises a substantially uniform density, the density of the panel 150 decreases through the core 156, in the direction of the cavity side 154 of the panel 150. In one exemplary embodiment, the density profile of the panel 150 ranges between specific gravities of approximately 1.05 at the surface 158 of the convex design feature 162 on the face side of the panel 150 to approximately 0.80 at the contact point 176 on the cavity side 154. More preferably, the density profile of the panel 20 will preferably range between specific gravities of approximately 1.00 at the surface 158 to approximately 0.85 at the surface 160. Thus less material is needed to form a lighter (i.e. less dense) panel 150 that is devoid of brown line defects.

In such design configurations, a wide variety of design features may be formed. In an exemplary embodiment, a design feature may be formed having a deflection angle greater than 38° between adjacent planes, and the overall design features may have an angle of 50° from a flat plane. Additionally, a bead element may be formed having a radius less than 0.031″. In an exemplary embodiment, a bead may be formed having a radius from 0.025″ to 0.062″ at the bottom and radius of 0.031″ to as little as 0.010″ at the surface. Additionally, design features may be formed while using a mat having a lower basis weight than typical. For example, sharp design features may be formed in a mat having a specific gravity of 0.85 compared to previous panels which would require a specific gravity of 1.0 or greater. These design features may give the panel the appearance of being made from natural wood having millwork as opposed to design features of other panels which may appear more synthetic. Though articles and methods of the present invention allow for sharper design features and panels having a reduced density, a variety of different design features and densities may be used without departing from the scope of the invention.

FIG. 4 is a fragmentary sectional view of a panel according to another embodiment of the invention. A panel 200 comprises a core 206, a first surface 208 on a face side 202 of the panel 200, and a second surface 210 on a cavity side 204 of the panel 200. The panel 200 further comprises a convex design feature 212 comprising an apex 214, a first adjacent base 218, and a second adjacent base 222. As shown in FIG. 4, the convex feature is created by a stepped corrective push. The stepped corrective push comprises a first contact point 226, a second contact point 228, and a third contact point 230, each respectively located on the cavity side 204 of the panel 200. Together, the three contact points 226, 228, 230 comprise a “triple ripple.” The three contact points 226, 228, 230 consolidate fiber at the apex of the convex design feature 212 on the face side 202 of the panel 250 by maximizing the compression forces pushing fiber toward the apex 214.

The apex 214 of the convex design feature 212 has a first caliper 216, as measured between the apex 214 and the contact point 226. The first adjacent base 218 has base calipers 220a, 220b. The second adjacent base 222 has base calipers 224a, 224b. Both pairs of the base calipers 220a, 220b and 224a, 224b are less, or thinner, than the first caliper 216 at the apex 214.

As best shown in FIG. 4A, a die set for manufacture of the panel 200 has a face side 202 and a cavity side 204. The contact point 226 can be seen, as well as the contact points 228 and 230. The apex 214 is provided by push 214′, whereas the bases 218 and 222 are provided by pushes 218′ and 222′. Those skilled in the art recognize that the dies of FIG. 4A are configured so that the surfaces 202 and 204 form the mat so as to have molded into it the features that are desired, such as the coves, beads, panels, etc.

Panels utilizing the principles of the present invention may be formed with any number of design elements, each having a variety of shapes and sizes. The thickness of the design elements may be increased from the lowest or deepest portion of the contoured region progressively to the flat regions. The thicknesses of design elements may gradually increase, with adjacent design elements having a variation in thickness between 5-7%. This increase in thickness may also be measured from a zone where the greatest change in deflection occurs from a previous zone, as apart from a lowest portion. The formation of design features having sharp convex deflection points in the profile requires a certain degree of additional compression adjacent to a convex point on both flanking sides of that convex point. The thinner sections adjacent to the convex point cause lateral movement of the fiber during press closure, thereby causing consolidation of fiber into the apex or convex point on the face side of the profile element. As with the adjacent design features, the thinner sections should not exceed a 5-7% reduction compared to the total thickness of the referenced bisected point (i.e. apex).

A panel formed with these dimensions can have a constant, or uniform, surface density, due to the movement of wood fiber material caused by internal forces during the forming process. The constant surface density may penetrate the depth of the panel a sufficient amount to avoid paint soaking in. For example, this properly densified surface depth may be in the range of 0.025″-0.030.″

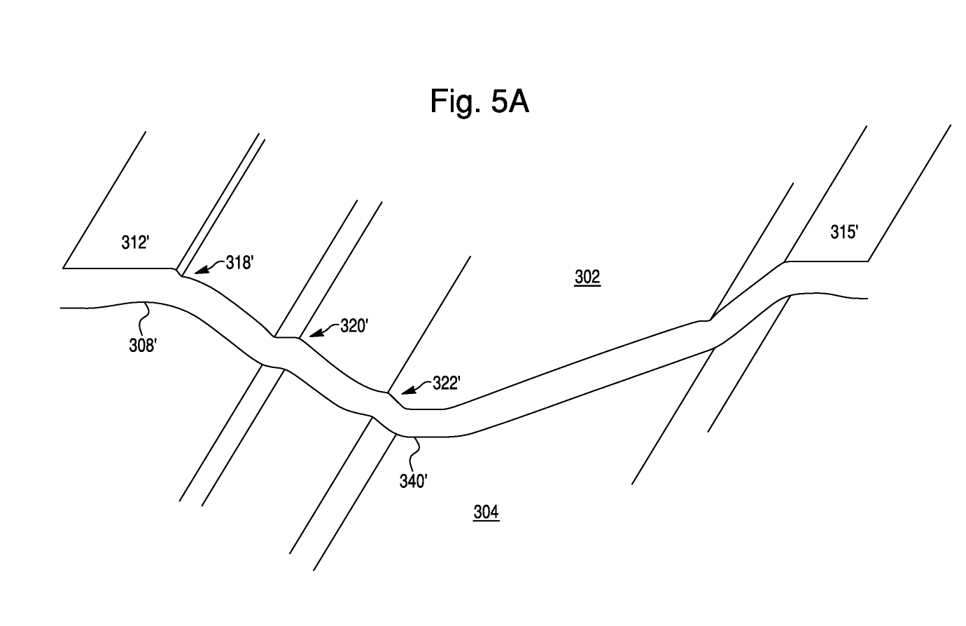

FIG. 5 is a fragmentary sectional view of a panel according to another embodiment of the invention. The panel 300 shown in FIG. 5 comprises a core 310, a first surface 306 on a face side 302 of the panel 300, and a second surface 308 on a cavity side 304 of the panel 300, the second surface 308 oppositely disposed the first surface 306. The panel 300 is divided into three regions, or zones: a first flat region 312, a second flat region 314, and a contoured region 316. The flat regions 312, 314, or the normal zones, comprise the thickest portion of the panel 300, whereas the panel 300 is thinner in the contoured region 316. The contoured region 316 extends below the flat regions and comprises a plurality of design features, including a bevel 318, a first convex feature 320, and a second convex feature 322. Each region comprises a constant or changing thickness or caliper. The first flat region 312 comprises a caliper 324.

In the embodiment shown in FIG. 5, the caliper of the panel 300 progressively decreases as the distance from the flat region 312 increases. As shown in FIG. 5, the bevel 318 is closer to the first flat region 312 than the first convex feature 320. Thus the caliper 326 at the bevel 318 is thinner than the flat region caliper 324, but thicker than the caliper 328 at the first convex feature 320. Similarly, since the first convex feature 320 is closer to the flat region 312 than the second convex feature 322, the caliper 328 of the first convex feature 320 is larger than the caliper 330 of the second convex feature 322.

The second convex feature 322 comprises a first base 336 proximate to the flat region 312 and a second base 338 distant from the flat region 312. The first base 336 comprises a first caliper 332 and the second base 338 comprises a second caliper 334. As shown in FIG. 5, the caliper 334 at the second base 338 distant from the flat region 312 is deflected approximately 45° from the flat region 312, and has the highest angle of deflection from the flat region 312 of any section of the contoured region 316. In certain methods and articles according to the current invention, the smallest caliper, or thinnest section, of the contoured region is at the highest angle of deflection from the flat region. Thus the panel 300 may be formed to have the thinnest section at the caliper 334.

The section 340 of the panel 300 is shown as the deepest section of the contoured region 316. In certain methods and articles according to the current invention, the smallest caliper of the contoured region is at the deepest section of the contoured region. Thus in some panels, the caliper 342 at the deepest section 340 is the smallest caliper of the panel 300.

As best shown in FIG. 5A, a die set having surfaces 302 and 304 is provided for forming the panel 300. In FIG. 5A structures of the dies forming corresponding features in the panel 300 are shown by like numbers augmented with a Thus, flat region 312 is formed by 312′, whereas flat 314 is formed by 314′. Those skilled in the art recognize that the dies of FIG. 5A have formed therein structures that create or mold into the mat the desired structural and ornamental features required for the panel 300.

Methods for creating panels without brown line defects are also provided. In one exemplary method, a mat of material is formed to have a first surface, a core, and a second surface oppositely disposed the first surface. The density of the panel is formed to be uniform, or substantially constant, across the first surface, and decreases through the core of the panel. Different amounts of pressure may be applied to different regions, or zones of the mat in order to give the finished panel the desired properties. For instance, less pressure will be applied to a convex feature such as a bed than to the bead's adjacent bases or cove portions, allowing the internal forces of the mat to push material towards the surface of the panel and into the bead.

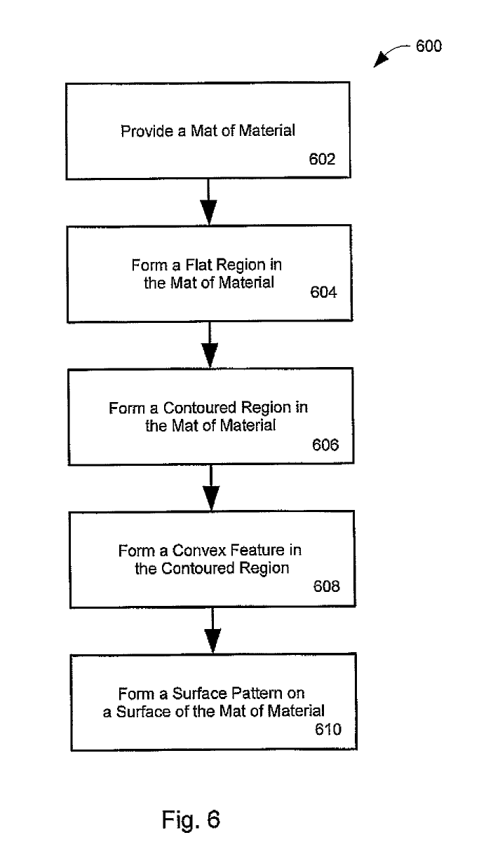

As another exemplary method, FIG. 6 is a flow diagram of another method according to the invention. In the method 600, a mat of material is first provided at 602. The mat of material is a wood fiber composite material, although flakes, wafers, particles, strands, or mixtures thereof may be used. The mat is preferably formed from wood fibers, and more preferably formed into a high density fiberboard.

A combination of steam and chemicals may be added to the mat before it is molded. For example, a vapor injection method using vapor ammonia and a surface spray method using liquid dimethyl sulfoxide may be applied to either one of or both sides of the mat before it is pressed. These chemicals may be used to further manipulate the density profile and enhance the cleavage strength of the panel.

After a mat of material is provided at 602, various regions are formed in the mat of material 604, 606. The mat of material is formed through a molding process, such as compression molding. For example, the mat of material may be introduced to a die set, and be subject to a combination of heat and pressure. One or more flat regions, or normal zones, are formed in the mat of material 604. The flat regions of the mat may be formed with a constant thickness, or caliper. The flat regions of the mat may ultimately form the border, or outside area, of a contoured door panel.

Next, a contoured region is formed in the mat of material. In some methods, the contoured region is formed at the same time as the flat region. As shown in FIG. 5, the contoured region may have an overall concave or depressed shape. Panels according to the present invention may comprise one or more contoured regions. The contoured region may be formed such that the smallest caliper of the contoured region is at the section of the contoured region most distant from the flat region, at the deepest section of the contoured region, and/or at the section with the highest angle of deflection from the contoured region. The mat of material may be formed such that the thickness of the contoured region progressively decreases as the distance from the flat region increases, thus creating a panel with the smallest caliper at the section of the contoured region most distant from the flat region.

A convex feature is then formed in contoured region of the mat of material 608. The convex feature comprises a first adjacent base with a first caliper, a second adjacent base with a second caliper, and an apex with a third caliper greater than the first caliper and the second caliper.

Optionally, a surface pattern may be formed on one or both surfaces of the mat of material 610. This pattern can have a fine surface texture small enough to not fully fill with fiber during the pressing cycle. Such textured patterns allow gases and moisture to vent from the mat during the molding process. The texture depth to width ratio may be 2 to 1. The pattern may be random direction lines or a uniform grid crossing each other or parallel to each other. The frequency of the pattern may be no closer than a ratio of 3 units of flat for line of surface texture. The texture element width may be between 0.0005″ to 0.002″, having a depth between 0.001″ to 0.004″.

A molded panel without brown line defects such as those provided by the present invention may be used in a number of applications. As one example, a panel will be used as a door facing having design features which simulate contoured paneling. In order to form a door, a first and second door facing are attached to a frame. The frame may comprise a lock stile, a hinge stile, a bottom rail, and a top rail. The door facings are preferably adhesively attached to the frame, though they may also be press fitted, mechanically fastened, or fastened through any other suitable means. The first and second door facings may be identical, or the exterior side door facing may differ from the interior side. Additionally, the interior of the door may be provided with a core material.

The foregoing description of preferred embodiments of the present invention has been presented for the purpose of illustration. It is not intended to be exhaustive or to limit the invention to the precise forms disclosed. Obvious modifications or variations are possible in light of the above teachings. The embodiments disclose hereinabove were chosen in order to best illustrate the principles of the present invention and its practical application to thereby enable those of ordinary skill in the art to best utilize the invention in various embodiments and with various modification as are suited to the particular use contemplated, as long as the principles described herein are followed. Thus, changes can be made in the above-described invention without departing from the intent and scope thereof. Moreover, features or components of one embodiment may be provided in another embodiment. Thus, the present invention is intended to cover all such modification and variations.

What is claimed is:

1. A panel, comprising:
a core comprising a flat region and a contoured region,
wherein the contoured region comprises a convex feature, a first adjacent base and a second adjacent base, the apex of the convex feature having a first caliper,
the first adjacent base having a second caliper smaller than the first caliper, and
the second adjacent base having a third caliper smaller than the first caliper.

2. The panel according to claim 1, wherein the second caliper and the third caliper are 1% to 8% smaller than the first caliper.

3. The panel according to claim 1, wherein the second caliper and the third caliper are 0.005 to 0.008 inches smaller than the first caliper.

4. The panel according to claim 1, wherein an angled section of the contoured region has an angle of deflection between 0° and 45° from the flat region.

5. The panel according to claim 1, wherein the second caliper of the first adjacent base is up to 35% less than a caliper of the first flat region.

6. The panel according to claim 1, wherein the second caliper is closer to the flat region than the third caliper and the third caliper is smaller than the second caliper.

7. The panel according to claim 1, wherein the thickness of the contoured region progressively decreases as the distance from the flat region increases.

8. The panel according to claim 1, wherein the smallest caliper of the contoured region is at the most distant section of the contoured region from the flat region.

9. The panel according to claim 1, wherein the smallest caliper of the contoured region is at the deepest section of the contoured region.

10. The panel according to claim 1, wherein the smallest caliper of the contoured region is at the highest angle of deflection from the flat region.

11. The panel according to claim 1, wherein the core comprises a first surface and a second surface opposite the first surface, wherein the first surface comprises texturing comprising indented channels leading from a first segment of the panel to a second segment of the panel.

12. The panel according to claim 1, wherein the core comprises high density fiberboard.

13. The panel according to claim 1, wherein the core further comprises a first surface and a second surface oppositely disposed the first surface, the surface density across the convex feature is substantially constant, the core density of the contoured region decreases through the core from the first surface to the second surface.

14. The panel according to claim 1, wherein the panel has a basis weight between 1.02 and 0.85 gravity.

15. A method for making a panel, the method comprising:
providing a mat of material;
forming a flat region in the mat of material;
forming a contoured region in the mat of material; and
forming a convex feature in the contoured region comprising a first adjacent base with a first caliper, a second adjacent base with a second caliper, and an apex with a third caliper greater than the first caliper and the second caliper.

16. The method according to claim 15, further comprising forming a surface texturing on a surface of the mat of material.

17. The method according to claim 15, wherein the mat of material is formed by molding the mat of material.

18. The method according to claim 15, wherein the mat of material comprises high density fiberboard.

19. The method according to claim 15, wherein forming the contoured region comprises
forming a first surface on the mat of material; and
forming a second surface oppositely disposed the first surface on the mat of material; wherein the density of the contoured region is formed to decrease from the first surface to the second surface.

20. A panel with varying densities comprising:
a first surface;
a second surface oppositely disposed the first major surface;
a core disposed between the first and second major surfaces;
wherein the density of the panel is substantially uniform along the first surface and decreases through the core of the panel.
